(19) United States
(12) Patent Application Publication
(10) Pub. No.: US 2016/0265450 A1
(43) Pub. Date: Sep. 15, 2016

(54) FUEL SUPPLY SYSTEM FOR MULTI-FUEL ENGINE

(71) Applicants: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(72) Inventors: Shoichiro TAKEKAWA, Nagoya-shi (JP); Takao KOMODA, Okazaki-shi (JP)

(73) Assignees: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(21) Appl. No.: 15/031,903

(22) PCT Filed: Nov. 24, 2014
(86) PCT No.: PCT/JP2014/080986

§ 371 Date: Apr. 25, 2016

(30) Foreign Application Priority Data
Nov. 28, 2013 (JP) 2013-246593

(51) Int. Cl. F02D 19/06; F02D 41/00

(52) U.S. Cl. CPC F02D 19/0615; F02D 41/0027; F02D 19/0647

(57) ABSTRACT

A fuel supply apparatus is applied to a multi-fuel engine. The multi-fuel engine is constructed such that the operation mode of the engine can be switched, while the engine is operating, between a liquid fuel operation mode, in which fuel is supplied by injecting a liquid fuel into an intake passage, and a gas fuel operation mode, in which fuel is supplied by injecting a gas fuel into intake air. The fuel supply apparatus is equipped with a control device that performs a decreasing correction of the injection amount of the gas fuel when the engine operation mode is switched from the liquid fuel operation mode to the gas fuel operation mode.

### TECHNICAL FIELD

The present invention relates to a fuel supply apparatus for a multi-fuel engine capable of switching the operation mode of an engine, when the engine is in operation, between a liquid fuel operation mode for supplying fuel by injecting liquid fuel into an intake passage and a gas fuel operation mode for supply fuel by injecting gas fuel into intake air.

### BACKGROUND ART

Conventionally, the engine described in Patent Document 1 is known as a multi-fuel engine capable of using a plurality of types of fuels. In the multi-fuel engine described in Patent Document 1, while the engine is maintained in operation, the operation mode of the engine is switchable, either manually or automatically, between a liquid fuel operation mode for injecting liquid fuel into an intake passage and a gas fuel operation mode for injecting gas fuel into intake air.

### PRIOR ART DOCUMENTS

### Patent Documents

Patent Document 1: Japanese Laid-Open Patent Publication No. 2006-342689

### SUMMARY OF THE INVENTION

### Problems that the Invention is to Solve

When liquid fuel is injected into an intake passage, some of the injected liquid fuel adheres to the wall surface of the intake passage. Then, the liquid fuel adhered to the wall surface of the intake passage gradually evaporates. That is, in a period immediately after switching from the liquid fuel operation mode to the gas fuel operation mode, the liquid fuel adhered to the wall surface of the intake passage remains from the liquid fuel operation mode. Therefore, in the period immediately after such switching of the operation modes, the liquid fuel evaporating from the wall surface of the intake passage is supplied to the combustion chamber in addition to the gas fuel supplied to the intake air. The amount of the fuel supplied to be burned thus becomes greater than the target amount. As a result, the air-fuel ratio becomes enriched temporarily and may destabilize combustion.

Accordingly, it is an objective of the present invention to provide a fuel supply apparatus for a multi-fuel engine that is capable of restraining destabilized combustion when the engine operation mode is switched from the liquid fuel operation mode to the gas fuel operation mode.

### Means for Solving the Problems

To achieve the foregoing objective and in accordance with one aspect of the present invention, a fuel supply apparatus for a multi-fuel engine is provided, in which the multi-fuel engine is configured to be capable of switching an operation mode of an engine, when the engine is in operation, between a liquid fuel operation mode for supplying fuel by injecting a liquid fuel into an intake passage and a gas fuel operation mode for supplying fuel by injecting a gas fuel into intake air. The fuel supply apparatus includes a control device, which performs a decreasing correction on an injection amount of the gas fuel when the engine operation mode is switched from the liquid fuel operation mode to the gas fuel operation mode.

### BRIEF DESCRIPTION OF THE DRAWINGS

FIG. 1 is a diagram representing the configuration of a fuel supply apparatus for a multi-fuel engine, as a whole, according to one embodiment;

FIG. 2 is a flowchart representing steps of a wall-wetting correction adapting procedure executed by the fuel supply apparatus of FIG. 1 when the engine operation mode is switched;

FIG. 3 is a graph representing the relationship between the number of times of CNG injection and the CNG wall-wetting correction amount after switching to a CNG operation mode;

FIG. 4 is a timing chart representing results obtained by executing the wall-wetting correction adapting procedure of FIG. 2 when the engine operation mode is switched from the gasoline operation mode to the CNG operation mode, in comparison with a case in which the wall-wetting correction adapting procedure is not executed; and

FIG. 5 is a timing chart representing results obtained by executing the wall-wetting correction adapting procedure of FIG. 2 when the engine operation mode is switched from the CNG operation mode to the gasoline operation mode, in comparison with a case in which the wall-wetting correction adapting procedure is not executed.

### MODES FOR CARRYING OUT THE INVENTION

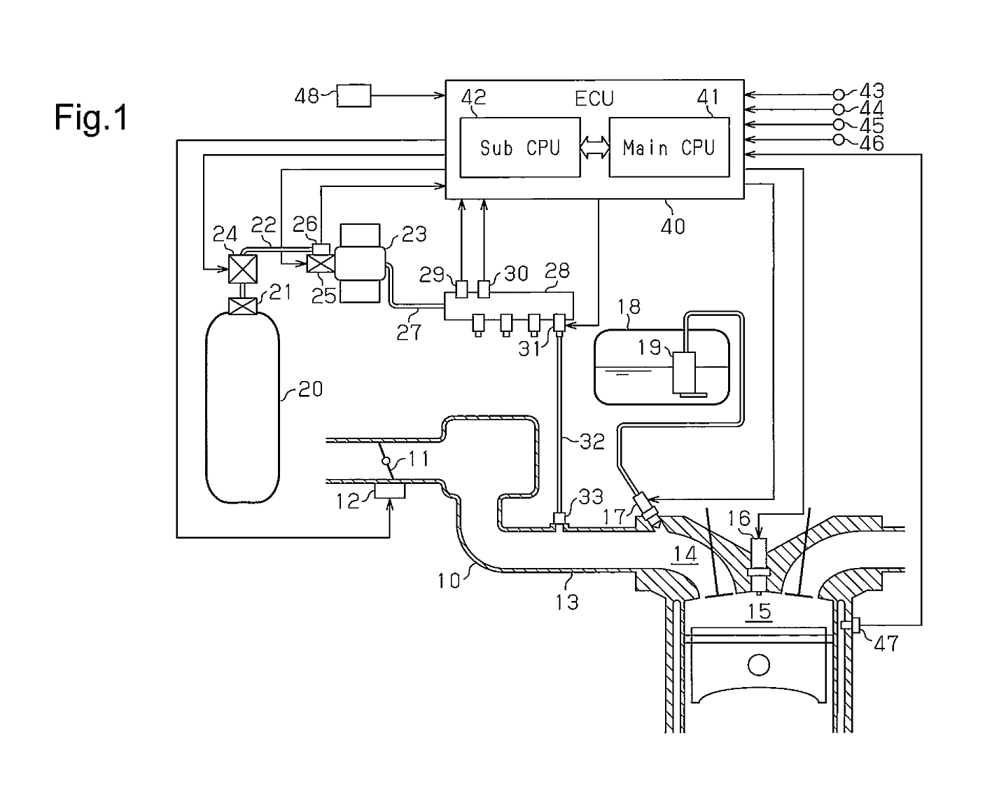

A fuel supply apparatus for a multi-fuel engine according to one embodiment of the present invention will now be described with reference to FIGS. 1 to 5. The fuel supply apparatus of the present embodiment is employed in an on-vehicle multi-fuel engine capable of switching the operation mode of the engine, when the engine is in operation, between a gasoline operation mode (a liquid fuel operation mode) for supplying fuel by injecting gasoline as liquid fuel, for example, into an intake passage, and a CNG operation mode (a gas fuel operation mode) for supplying fuel by injecting compressed natural gas (CNG) as a gas fuel, for example, into intake air. The multi-fuel engine is designed using a gasoline engine as a base to which a CNG supply system and the like are added.

As shown in FIG. 1, the multi-fuel engine, in which the fuel supply apparatus of the present embodiment is employed, includes a throttle valve 11 in an intake passage 10. The throttle valve 11 is driven by a throttle motor 12 such that the opening degree of the throttle valve 11 is adjusted to change the flow cross-sectional area of the intake passage 10. The intake passage 10 is branched for respective cylinders in an intake manifold 13, which is arranged downstream of the throttle valve 11. An intake port 14 is connected to each of the branch ends of the intake manifold 13. Each of the intake ports 14 is connected to a combustion chamber 15 of the corresponding one of the cylinders. A spark plug 16, which sparks to ignite the air-fuel mixture introduced into the combustion chamber 15 of each cylinder, is arranged in the combustion chamber 15.

A gasoline injector 17, which injects gasoline serving as liquid fuel, is arranged in the intake port 14 of each cylinder. Gasoline is supplied to each of the gasoline injectors 17 after having been pumped out of a gasoline tank 18 storing gasoline by a fuel pump 19.

The vehicle, in which the multi-fuel engine is installed, includes a CNG cylinder 20 for storing CNG, which is gas fuel, in a high-pressure state. A manual valve 21, which is manually operated to block outflow of CNG, is arranged in the CNG cylinder 20. A high-pressure CNG pipe 22 is connected to the CNG cylinder 20 via the manual valve 21. The CNG cylinder 20 is joined to a CNG regulator 23, which depressurizes the CNG that has been delivered from the CNG cylinder 20 to a required pressure through the high-pressure CNG pipe 22. An oil separator, which separates oil elements from CNG, is incorporated in the CNG regulator 23.

The high-pressure CNG pipe 22 includes shutoff valves 24, 25, each of which blocks CNG communication, at positions between the CNG cylinder 20 and the CNG regulator 23. The shutoff valves 24, 25 become open at the start of the CNG operation mode and closed at the end of the CNG operation mode. The high-pressure CNG pipe 22 includes a high-pressure-side fuel pressure sensor 26, which detects the pressure of the CNG flowing in the high-pressure-side fuel pressure sensor 26, at a position between the shutoff valves 24, 25.

A low-pressure CNG pipe 27 is connected to a CNG outlet port of the CNG regulator 23. The CNG regulator 23 is joined to a CNG delivery pipe 28 via the low-pressure CNG pipe 27. The CNG delivery pipe 28 retains the low-pressure CNG that has been depressurized by the CNG regulator 23. The CNG delivery pipe 28 includes a low-pressure-side fuel pressure sensor 29, which detects the pressure of the CNG in the low-pressure-side fuel pressure sensor 29, and a low-pressure-side fuel temperature sensor 30, which detects the temperature of the CNG in the low-pressure-side fuel temperature sensor 30. CNG injectors 31, the number of which corresponds to the number of cylinders of the multi-fuel engine, are attached to the CNG delivery pipe 28. A CNG hose 32 is connected to each of the CNG injectors 31. CNG nozzles 33, which are arranged in the intake manifold 13, are connected to the corresponding CNG hoses 32.

The fuel supply apparatus of the present embodiment includes a control device, which is an electronic control unit (ECU) 40 that controls the multi-fuel engine. The electronic control unit 40 includes two central processing units (CPUs), which perform computation procedures for engine control, which are a main CPU 41 and a sub CPU 42. The sub CPU 42 performs computation procedures necessary for executing the CNG operation mode and computation procedures for controlling the CNG supply system. The main CPU 41 performs computation procedures other than the aforementioned computation procedures. The electronic control unit 40 includes drive circuits that drive the throttle motor 12, the spark plugs 16, the gasoline injectors 17, the shutoff valves 24, 25, the CNG injectors 31, and the like.

Detection signals are input to the electronic control unit 40 separately from various types of sensors, which are arranged in corresponding portions of the vehicle. The detection signals input to the electronic control unit 40 include detection signals from the high-pressure-side fuel pressure sensor 26, the low-pressure-side fuel pressure sensor 29, and the low-pressure-side fuel temperature sensor 30. The detection signals input to the electronic control unit 40 also include detection signals from a vehicle speed sensor 43, which detects the vehicle speed, an accelerator pedal sensor 44, which detects the depression amount of the accelerator pedal, an airflow meter 45, which detects the intake air amount, a crank angle sensor 46, which detects the crank angle, and a coolant temperature sensor 47, which detects the coolant temperature of the engine. A CNG switch 48, with which the user manually switches the operation mode of the multi-fuel engine between the gasoline operation mode and the CNG operation mode, is connected to the electronic control unit 40.

The multi-fuel engine, which is configured in the above-described manner, is started at the gasoline operation mode. When the gasoline operation mode is in execution, the main CPU 41 computes a gasoline injection amount based on an operating state of the multi-fuel engine, which includes, for example, the engine speed and/or the intake load factor. The main CPU 41 then drives the gasoline injectors 17 to inject gasoline by the amount corresponding to the computed gasoline injection amount. Also, when computing the gasoline injection amount, the main CPU 41 performs various types of correction on the gasoline injection amount, including wall-wetting correction of the gasoline injection amount.

Some of the gasoline injected from the gasoline injectors 17 does not mix with intake air and, while remaining in the liquid state, adheres to the wall surface of the intake ports 14 (hereinafter, referred to as the port wall surface). That is, some of the gasoline injected from the gasoline injectors 17 is not burned immediately. The gasoline that adheres to the port wall surface gradually evaporates and flows into each combustion chamber 15 together with the intake air. As a result, the gasoline that evaporates from the port wall surface is burned in the combustion chambers 15, in addition to the gasoline injected by the gasoline injectors 17. This causes a difference between the gasoline injection amount of the gasoline injector 17 and the amount of the gasoline that is actually burned. The wall-wetting correction of the gasoline injection amount is performed to correct this difference.

For the wall-wetting correction of the gasoline injection amount, the main CPU 41 estimates the amount of the gasoline adhered to the port wall surface and the evaporation rate of the gasoline from the port wall surface based on the engine speed and the intake load factor and/or the coolant temperature of the multi-fuel engine. Also, the main CPU 41 computes a correction amount of the gasoline injection amount, which is a gasoline wall-wetting correction amount, based on the estimates. The main CPU 41 then reflects the computed gasoline wall-wetting correction amount on the actual gasoline injection amount. This restrains deviation of the air-fuel ratio caused by the gasoline adhered to the port wall surface and the gasoline evaporating from the port wall surface when air-fuel mixture containing gasoline is burned in the combustion chambers 15. The same logic as the logic employed for the gasoline engine that is used as the base is employed without being modified for the wall-wetting correction of the gasoline injection amount.

When a specified switching condition is satisfied and the CNG switch 48 is turned on, the operation mode of the multi-fuel engine is switched from the gasoline operation mode to the CNG operation mode. That is, gasoline injection by the gasoline injectors 17 is stopped and CNG injection by the CNG injectors 31 into the intake air in the intake manifold 13 is started. A switching condition for switching from the gasoline operation mode to the CNG operation mode includes a condition that the amount of the CNG remaining in the CNG cylinder 20 is greater than or equal to a certain amount and warm-up of the multi-fuel engine is complete with the engine speed greater than or equal to a certain speed.

When the CNG operation mode is in execution, the CNG injection by the CNG injectors 31 is controlled by the sub CPU 42. That is, the sub CPU 42 computes the CNG injection amount based on the operating state of the multi-fuel engine and drives the CNG injectors 31 to inject CNG by the amount corresponding to the computed CNG injection amount.

If the CNG switch 48 is turned off or the aforementioned switching condition becomes unsatisfied when the CNG operation mode is in operation, the operation mode of the multi-fuel engine is switched to the gasoline operation mode. That is, the CNG injection by the CNG injectors 31 into the intake air in the intake manifold 13 is stopped and the gasoline injection by the gasoline injectors 17 is resumed.

To restrain destabilized combustion caused by switching of the engine operation mode, the fuel supply apparatus of the present embodiment executes a wall-wetting correction adapting procedure when the engine operation mode is switched. The adapting procedure is executed by the sub CPU 42.

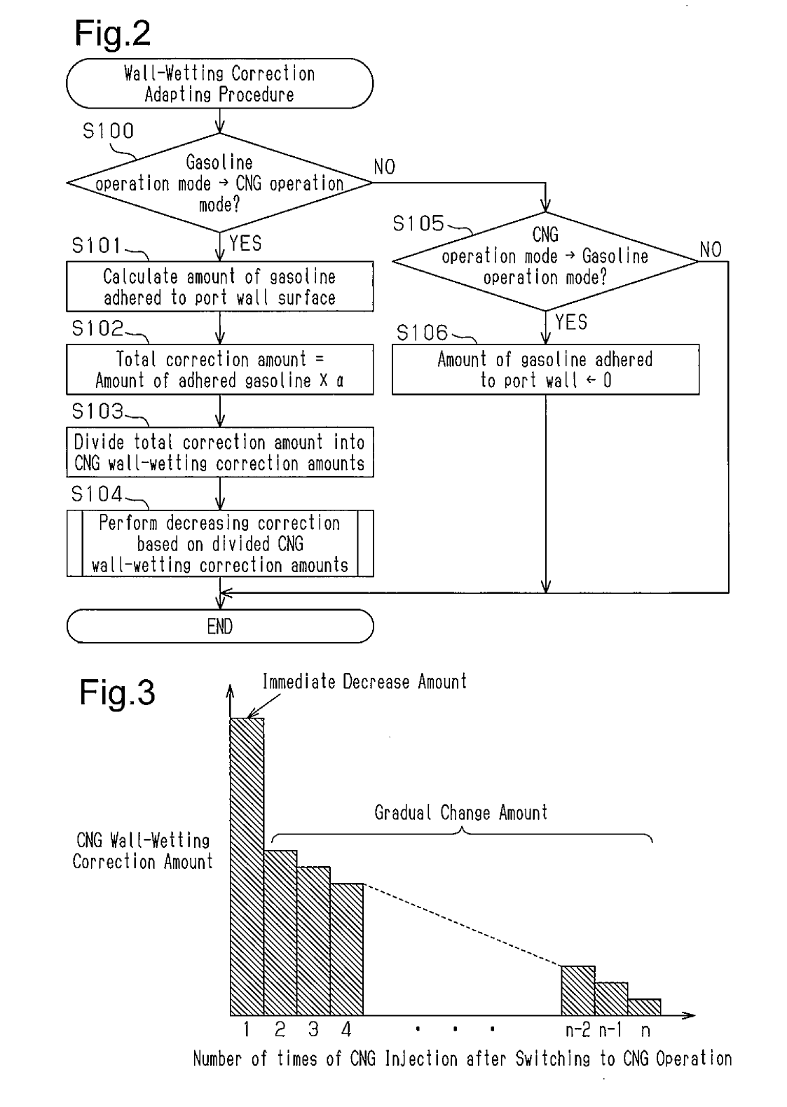

FIG. 2 shows steps of the wall-wetting correction adapting procedure performed at the time of switching of the operation mode. The sub CPU 42 executes the adapting procedure repeatedly by specific control cycles when the multi-fuel engine is in operation.

The procedure is started by Step S100, in which it is determined whether the gasoline operation mode will be switched to the CNG operation mode. If a positive determination is made at step 100, Step S101 is carried out.

At step S101, the current amount of the gasoline adhered to the port surface is calculated based on the coolant temperature, the intake air load factor, and the engine speed of the multi-fuel engine.

Then, at step S102, the CNG injection amount corresponding to the amount of the adhering gasoline calculated at step 101 is determined as a total correction amount of decreasing correction. The total correction amount is computed by multiplying the amount of the adhering gasoline by a specific coefficient α. The proportion (Sg/Sc) of the gasoline stoichiometric air-fuel ratio Sg to the CNG stoichiometric air-fuel ratio Sc is set as the coefficient α.

Subsequently, at step S103, the total correction amount determined at step S102 is divided into CNG wall-wetting correction amounts, which are employed for a number of times of CNG injection after switching to the CNG operation mode.

FIG. 3 shows the manner in which the total correction amount is divided at step S103. As is clear from the graph, the total correction amount is divided into, generally, an immediate decrease amount and a gradual change amount. The immediate decrease amount is the CNG wall-wetting correction amount employed for the initial CNG injection after switching to the CNG operation mode. The immediate decrease amount is set to be the greatest among the divided CNG wall-wetting correction amounts. On the other hand, the gradual change amount is the CNG wall-wetting correction amounts employed for the second and subsequent CNG injections after switching to the CNG operation mode. The values of the gradual change amount are set to gradually reduce as the cycles of CNG injection progress after switching to the CNG operation mode. By setting the CNG wall-wetting correction amounts employed for the respective CNG injections such that the sum of the CNG wall-wetting correction amounts employed for a number of times of CNG injection corresponds to the total correction amount determined at step S102, the aforementioned total correction amount is divided. A fixed value or a variable value corresponding to the total correction amount or the like is set to the number of times of CNG injection that is the target of division of the total correction amount.

After the division of the total correction amount is completed, the subsequent step, step S104, is carried out to execute the wall-wetting correction on the CNG injection amount based on the CNG wall-wetting correction amounts divided at step S103. The decreasing correction is thus performed on the CNG injection amount. Then, the current adapting procedure is ended.

In contrast, if a negative determination is made at step S101, step 105 of the procedure is carried out. At step S105, it is determined whether the CNG operation mode will be switched to the gasoline operation mode. If a negative determination is made, the current adapting procedure is ended. If a positive determination is made, step 106 of the procedure is carried out.

At step S106, the estimate of the amount of the gasoline adhered to the port wall surface, which is computed by the main CPU 41, is reset to 0. Then, the current adapting procedure is ended.

Switching from Gasoline Operation Mode to CNG Operation Mode

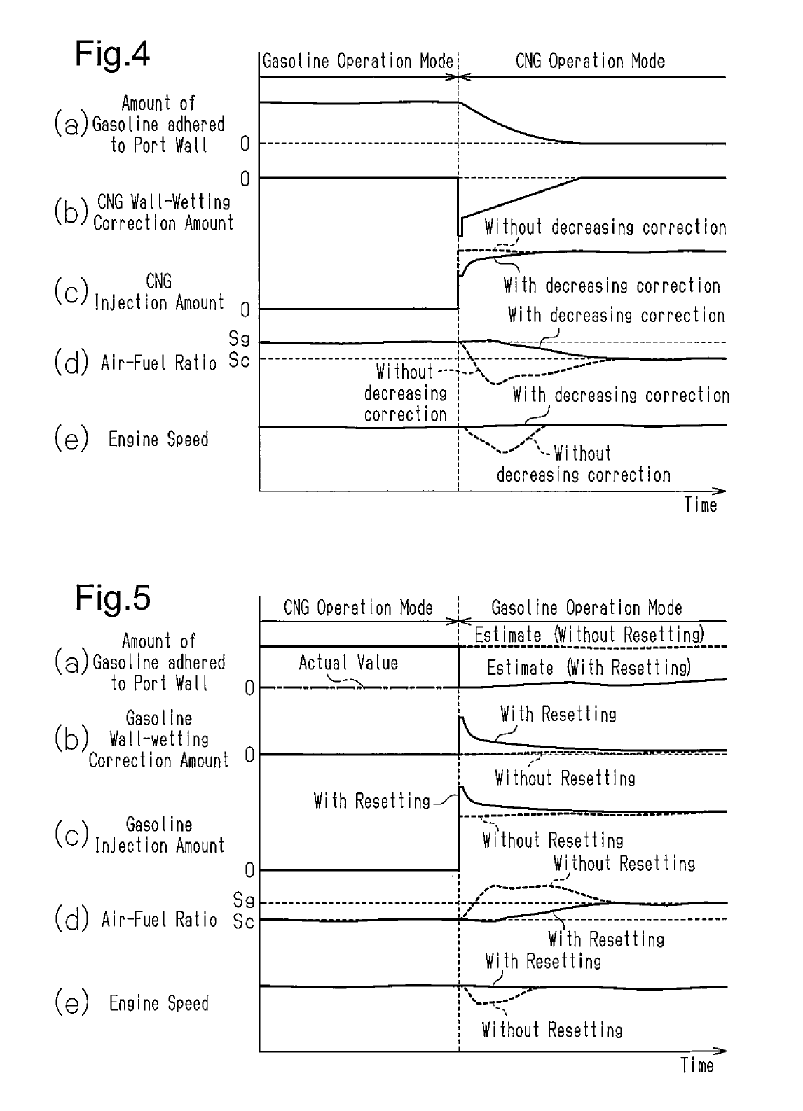

FIG. 4 shows examples of results obtained by executing the wall-wetting correction adapting procedure, as compared to results of a case in which the procedure is not executed, when the operation mode of the multi-fuel engine is switched from the gasoline operation mode to the CNG operation mode.

Referring to section (a) of FIG. 4, in a period immediately after switching from the gasoline operation mode to the CNG operation mode, the gasoline adhered to the port wall surface remains from the gasoline operation mode. Afterwards, the gasoline adhered to the port wall surface gradually evaporates into intake air and is thus gradually reduced. The gasoline evaporating from the port wall surface flows into the combustion chambers 15 together with the intake air. That is, in a certain period after switching to the CNG operation mode, the gasoline evaporating from the port wall surface is burned, in addition to the CNG injected by the CNG injectors 31.

In the case in which the wall-wetting correction adapting procedure is not executed, the CNG injection amount after switching to the CNG operation mode is set regardless of the gasoline evaporating from the port wall surface. In this case, after switching to the CNG operation mode, the gasoline evaporating from the port wall surface flows into the combustion chambers 15 and the amount of fuel to be burned becomes excessive. Therefore, as represented by the broken line in section (d) of FIG. 4, the air-fuel ratio of the air-fuel mixture burned in the combustion chambers 15 after switching to the CNG operation mode becomes significantly lower than the CNG stoichiometric air-fuel ratio Sc. That is, the air-fuel ratio is enriched. As a result, destabilized combustion is caused and the engine speed fluctuates as represented by the broken line in section (e) of FIG. 4.

In the fuel supply apparatus of the present embodiment, the total correction amount corresponding to the amount of the gasoline adhered to the port wall surface at the time of switching to the CNG operation mode is divided into the CNG wall-wetting correction amounts, which are employed for a number of times of CNG injection. With reference to section (b) of FIG. 4, the divided CNG wall-wetting correction amounts are set for a number of times of CNG injection after switching to the CNG operation mode. As a result, as represented by the solid line in section (c) of FIG. 4, the decreasing correction is performed on the CNG injection amount. Such decreasing correction of the CNG injection corrects enrichment of the air-fuel ratio caused by the gasoline evaporating from the port wall surface. As a result, in the present embodiment, as represented by the solid line in section (d) of FIG. 4, the air-fuel ratio after switching to the CNG operation mode smoothly changes from the target air-fuel ratio in the gasoline operation mode (in this example, the gasoline stoichiometric air-fuel ratio Sg) to the target air-fuel ratio in the CNG operation mode (in the example, the CNG stoichiometric air-fuel ratio Sc), compared to the case in which the wall-wetting correction adapting procedure is not executed (represented by the broken line in section (d) of FIG. 4). As a result, in this embodiment, deteriorated combustion after switching to the CNG operation mode is restrained and, as represented by the solid line in section (e) of FIG. 4, fluctuation of the engine speed is restrained.

After switching to the CNG operation mode, the gasoline adhered to the port wall surface evaporates and is gradually reduced. Correspondingly, the evaporation rate of the gasoline gradually decreases. Therefore, in the present embodiment, the amount of the decreasing correction of the CNG injection amount is gradually reduced in correspondence with the time elapsed from switching to the CNG operation mode, or, in other words, increase of the number of times of injection.

The sum of the gasoline flowing into the combustion chambers 15 since switching to the CNG operation mode is the amount of the gasoline adhered to the port wall surface at the time of switching to the CNG operation mode. To correct the deviation of the air-fuel ratio caused by the gasoline flowing into the combustion chambers 15, the decreasing correction amount of the CNG injection amount must be calculated taking into account the proportion of the gasoline stoichiometric air-fuel ratio Sg to the CNG stoichiometric air-fuel ratio Sc. In this regard, in the present embodiment, to correct such deviation of the air-fuel ratio, decreasing correction is performed on the CNG injection amount using, as the total correction amount, the value obtained by multiplying the amount of the gasoline adhered to the port wall surface at the time of switching to the CNG operation mode by the aforementioned proportion (Sg/Sc) of the stoichiometric air-fuel ratio.

Switching from CNG Operation Mode to Gasoline Operation Mode

FIG. 5 represents examples of results obtained by executing the wall-wetting correction adapting procedure, as compared to results of a case in which the procedure is not executed, when the operation mode of the multi-fuel engine is switched from the CNG operation mode to the gasoline operation mode.

In the CNG operation mode, gasoline injection into the intake ports 14 is suspended and the gasoline that adhered to the port wall surface due to the gasoline injection before the suspension has already evaporated. Therefore, as represented by the long dashed short dashed line in section (a) of FIG. 5, in a period of the CNG operation mode immediately before switching to the gasoline operation mode, the amount of the gasoline adhered to the port wall surface is substantially 0. As a result, in a period immediately after switching to the gasoline operation mode, the gasoline injected by the gasoline injectors 17 is sprayed onto the dry port wall surface and the amount of the gasoline adhered to the port wall surface increases significantly.

As has been described, the main CPU 41 performs the wall-wetting correction of the gasoline injection amount employing, without modification, the same logic as the logic employed for the gasoline engine used as the base. However, the logic for the wall-wetting correction of the gasoline injection amount does not include a case in which the gasoline injection is suspended due to the CNG operation mode. Therefore, as represented by the broken line in section (a) of FIG. 5, the estimate of the amount of the adhering gasoline, which is computed by the main CPU 41, is computed to maintain the estimate at the time point of switching to the CNG operation mode. Also, as represented by the broken line in section (b) of FIG. 5, the gasoline wall-wetting correction amount after switching to the gasoline operation mode is calculated in correspondence with the aforementioned estimate of the amount of the adhering gasoline. Therefore, if, as represented by the broken line in section (c) of FIG. 5, the gasoline injection amount is set with the calculated gasoline wall-wetting correction amount reflected without modification, the fuel to be burned becomes insufficient. As a result, after switching to the gasoline operation mode, the air-fuel ratio becomes lean as represented by the broken line in section (d) of FIG. 5 and the engine speed fluctuates as represented by the broken line in section (e) of FIG. 5.

In the fuel supply apparatus of the present embodiment, as represented by the solid line in section (a) of FIG. 5, the estimate of the amount of the gasoline adhered to the port wall surface is reset temporarily to 0 at the time of switching to the gasoline operation mode. Therefore, in the present embodiment, the gasoline wall-wetting correction amount after switching to the gasoline operation mode is set as represented by the solid line in section (b) of FIG. 5. As represented by the solid line in section (c) of FIG. 5, the gasoline injection amount is increased to a greater extent in the present embodiment than in the case in which the wall-wetting correction adapting procedure is not performed (represented by the broken line in section (c) of FIG. 5). Therefore, as represented by the solid line in section (d) of FIG. 5, in the present embodiment, the air-fuel ratio after switching to the gasoline operation mode smoothly changes from the target air-fuel ratio in the CNG operation mode (in this example, the CNG stoichiometric air-fuel ratio Sc) to the target air-fuel ratio in the gasoline operation mode (in the example, the gasoline stoichiometric air-fuel ratio Sg), compared to the case in which the wall-wetting correction adapting procedure is not performed (represented by the broken line in section (d) of FIG. 5). As a result, in this embodiment, deteriorated combustion after switching to the gasoline operation mode is restrained. Also, as represented by the solid line in section (e) of FIG. 5, fluctuation of the engine speed is restrained.

In the present embodiment, by resetting the estimate of the amount of gasoline adhered to the port wall surface to 0 at the time of switching to the gasoline operation mode, the increasing correction of the gasoline injection amount by the wall-wetting correction is performed after switching to the gasoline operation mode. The amount of the gasoline adhered to the port wall surface after switching to the gasoline operation mode gradually increases to a certain extent as the gasoline injection progresses. Therefore, the amount of the increasing correction of the gasoline injection amount is gradually reduced in correspondence with the time elapsed from switching to the gasoline operation mode, or, in other words, in correspondence with increase of the number of times of injection.

The above described embodiment achieves the following advantages.

(1) The fuel supply apparatus for a multi-fuel engine of the present embodiment performs the wall-wetting correction adapting procedure to carry out decreasing correction on the CNG injection amount when the gasoline operation mode is switched to the CNG operation mode. This restrains enrichment of the air-fuel ratio after switching to the CNG operation mode and destabilization of combustion caused by the enrichment of the air-fuel ratio.

(2) The amount of the decreasing correction of the CNG injection amount through the wall-wetting correction is gradually reduced in correspondence with the time elapsed from switching to the CNG operation mode, or, in other words, in correspondence with increase of the number of times of injection. This enables appropriate decreasing correction corresponding to the actual change of the amount of the gasoline adhered to the port wall surface after switching to the CNG operation mode.

(3) The total correction amount of the decreasing correction after switching to the CNG operation mode is calculated by multiplying the amount of the gasoline adhered to the port wall surface at the time of switching to the CNG operation mode by the proportion of the gasoline stoichiometric air-fuel ratio Sg to the CNG stoichiometric air-fuel ratio Sc. This enables appropriate decreasing correction corresponding to the actual amount of the gasoline adhered to the port wall surface.

(4) By resetting the estimate of the amount of the gasoline adhered to the port wall surface to 0 at the time of switching from the CNG operation mode to the gasoline operation mode, the wall-wetting correction adapting procedure is executed after switching to the gasoline operation mode and thus increasing correction is performed on the gasoline injection amount. This restrains reduction of the gasoline to be burned and restrains destabilized combustion caused by leaning of the air-fuel ratio after switching to the gasoline operation mode. As a result of the aforementioned resetting of the estimate of the amount of the adhering gasoline, the amount of the increasing correction of the gasoline injection amount through the wall-wetting correction is gradually reduced in correspondence with the time elapsed from switching to the gasoline operation mode, or, in other words, in correspondence with increase of the number of times of injection. This enables appropriate increasing correction corresponding to the actual change of the amount of the gasoline adhered to the port wall surface after switching to the gasoline operation mode.

The above illustrated embodiment may be modified as follows.

In the illustrated embodiment, by resetting the estimate of the amount of the gasoline adhered to the port wall surface to 0 at the time of switching to the gasoline operation mode, the wall-wetting correction adapting procedure is performed and thus the increasing correction is performed on the gasoline injection amount. However, without performing the wall-wetting correction adapting procedure, increasing correction different from the wall-wetting correction may be performed on the gasoline injection amount to restrain leaning of the air-fuel ratio after switching to the gasoline operation mode. Also in this case, by gradually reducing the amount of the increasing correction in correspondence with the time elapsed from switching to the gasoline operation mode, appropriate increasing correction of the gasoline injection amount corresponding to actual change of the amount of the gasoline adhered to the port wall surface may be performed.

In the illustrated embodiment, the amount of the increasing correction of the gasoline injection amount through the wall-wetting correction is gradually reduced in correspondence with the time elapsed from switching to the gasoline operation mode. However, regardless of the time elapsed from switching to the gasoline operation mode, the amount of the increasing correction on the gasoline injection amount may be maintained constant. Also in this case, leaning of the air-fuel ratio after switching to the gasoline operation mode is limited.

Only decreasing correction of the CNG injection amount after switching to the CNG operation mode may be performed without performing increasing correction of the gasoline injection amount after switching to the gasoline operation mode. In this case, enrichment of the air-fuel ratio after switching to the CNG operation mode is restrained.

In the illustrated embodiment, the total correction amount is divided for the CNG wall-wetting correction amounts employed for a number of times of CNG injection, which are performed after switching to the CNG operation mode. However, such division may be performed in a manner different from the manner of the illustrated embodiment.

In the illustrated embodiment, the total correction amount of the decreasing correction is calculated as the CNG injection amount corresponding to the amount of the gasoline adhered to the port wall surface at the time of switching to the CNG operation mode. However, the total correction amount may be calculated as a different value.

In the illustrated embodiment, by determining the total correction amount of the decreasing correction and dividing the determined total correction amount for a number of times of CNG injection after switching to the CNG operation mode, the CNG wall-wetting correction amounts employed for the respective CNG injections are set. However, without determining the total correction amount, the CNG wall-wetting correction amounts employed for the respective CNG injections may be set independently from one another. Alternatively, the CNG wall-wetting correction amounts may be set collectively.

In the illustrated embodiment, the amount of the decreasing correction of the CNG injection amount through the wall-wetting correction is gradually reduced in correspondence with the time elapsed from switching to the CNG operation mode. However, regardless of the time elapsed from switching to the CNG operation mode, the amount of the decreasing correction on the CNG injection amount may be maintained constant. Also in this case, enrichment of the air-fuel ratio after switching to the CNG operation mode is limited.

The fuel supply apparatus of the illustrated embodiment may be employed in a multi-fuel engine that uses a liquid fuel other than gasoline or a gas fuel other than CNG in the same manner as the illustrated embodiment or a manner similar to the manner of the embodiment.

1. A fuel supply apparatus for a multi-fuel engine, wherein the multi-fuel engine is configured to be capable of switching an operation mode of an engine, when the engine is in operation, between a liquid fuel operation mode for supplying fuel by injecting a liquid fuel into an intake passage and a gas fuel operation mode for supplying fuel by injecting a gas fuel into intake air,
wherein the fuel supply apparatus comprises a control device, which performs a decreasing correction on an injection amount of the gas fuel when the engine operation mode is switched from the liquid fuel operation mode to the gas fuel operation mode.

2. The fuel supply apparatus according to claim 1, wherein, when the decreasing correction is in execution, the control device gradually reduces an amount of the decreasing correction in correspondence with the time elapsed from switching to the gas fuel operation mode.

3. The fuel supply apparatus according to claim 1, wherein, when the decreasing correction is in execution, the control device gradually reduces an amount of the decreasing correction in correspondence with increase of the number of times of injection of the gas fuel from switching to the gas fuel operation mode.

4. The fuel supply apparatus according to claim 1, wherein a total amount of the decreasing correction is set to a value obtained by multiplying an amount of the liquid fuel adhered to a wall surface of the intake passage at the time of switching to the gas fuel operation mode by a proportion of a stoichiometric air-fuel ratio of the liquid fuel to a stoichiometric air-fuel ratio of the gas fuel.

5. The fuel supply apparatus according to claim 1, wherein the control device performs an increasing correction on an injection amount of the liquid fuel when the engine operation mode is switched from the gas fuel operation mode to the liquid fuel operation mode.

6. The fuel supply apparatus according to claim 5, wherein, when the increasing correction is in execution, the control device gradually reduces an amount of the increasing correction in correspondence with the time elapsed from switching to the liquid fuel operation mode.

7. The fuel supply apparatus according to claim 5, wherein, when the increasing correction is in execution, the control device gradually reduces an amount of the increasing correction in correspondence with increase of the number of times of injection of the liquid fuel from switching to the liquid fuel operation mode.

8. The fuel supply apparatus according to claim 1, wherein the liquid fuel is gasoline, and the gas fuel is a compressed natural gas.
